(19) United States
(12) Patent Application Publication
(10) Pub. No.: US 2016/0152791 A1
(43) Pub. Date: Jun. 2, 2016

(54) NANODIAMOND COMPOSITES AND METHODS FOR THEIR SYNTHESIS

(71) Applicant: University of Washington, Seattle, WA (US)

(72) Inventors: Peter J. Pauzauskie, Seattle, WA (US); Matthew B. Lim, Seattle, WA (US); Sandeep Manandhar, Seattle, WA (US)

(73) Assignee: University of Washington, Seattle, WA (US)

(21) Appl. No.: 14/949,754

(22) Filed: Nov. 23, 2015

Related U.S. Application Data
(60) Provisional application No. 62/083,017, filed on Nov. 21, 2014.

(51) Int. Cl. C08K 3/04; C08J 9/28; C08J 9/00; C08K 3/08

(52) U.S. Cl. CPC C08K 3/04; C08K 3/08; C08J 9/28; C08J 9/0066; C08K 2003/0856; C08J 2361/12

(57) ABSTRACT

Disclosed herein are nanodiamond composites and methods for their synthesis. In particular, the nanodiamond composites include large-surface-area polymer composites that include a polymer and nanodiamond dispersed and bound therein. The resulting composites having certain properties of diamond (e.g., drug-loading sites with low toxicity) yet are inexpensive and relatively easy to fabricate. Aerogels formed using a polycondensation polymer are particularly described herein, although many polymer systems are compatible. Synthesis of the nanodiamond composites is achieved by polymerizing a mixture of nanodiamond and a polymer precursor.

### CROSS-REFERENCE TO RELATED APPLICATION

This application claims the benefit of U.S. Provisional Application No. 62/083,017, filed on Nov. 21, 2014, the disclosure of which is hereby incorporated by reference in its entirety.

### BACKGROUND

The extreme physical and chemical properties as well as low toxicity of detonation nanodiamond (DND) materials have led to great interest recently in using these materials for both therapeutic and diagnostic applications in nanomedicine as well as for electrochemical supercapacitors. Currently, most of the nanodiamonds are manufactured through the detonation of explosives containing carbon followed by chemical purification of explosion-produced soot, which results in diamond grains with diameters in the range of single-digit-nanometers. Nanodiamond materials are under investigation for biomedical imaging and drug delivery applications based on their low toxicity and demonstrated biocompatibility. Furthermore, negatively charged nitrogen-vacancy color centers can be used for bright, photostable biolabelling applications based on extended red emission at ˜700 nm and near-unit fluorescence quantum yield.

Nanodiamond materials with high surface areas are of interest for numerous photocatalytic, photonic, astrophysical, and drug-delivery applications. Water-based nanodiamond gels have also been demonstrated to have a significant impact on the thermodynamic behavior of water confined within nanoscale pores. High-pressure, high-temperature (HPHT) synthetic approaches have been reported recently to produce high surface-area diamond aerogel materials in a laser-heated diamond anvil cell as well as mesoporous diamond using a multi-anvil press. These materials are of interest because aerogels are lightweight, have high surface areas, and contain abundant open pores which can be readily loaded with drugs or other compounds to be used as an effective payload delivery vessel. However, HPHT processing is costly in terms of both capital equipment as well as processing time. Developing chemical approaches to high surface area diamond synthesis would greatly increase availability and reduce cost for a range of applied and fundamental scientific applications.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a method of producing a nanodiamond composite is provided. In one embodiment, the method includes:

forming a gel by mixing oxidized diamond nanocrystals, a solvent capable of dispersing the oxidized diamond nanocrystals, and a polymer precursor system configured to form a polymer when reacted, wherein the gel comprises the solvent and the polymer having the oxidized diamond nanocrystals dispersed and bound therein.

In addition to the methods described herein, nanodiamond compositions formed using the disclose methods are also provided. Accordingly, in another aspect, a nanodiamond composite is provided that is formed by the methods described herein.

In yet another aspect, a nanodiamond aerogel is provided, whether made from the disclosed methods or otherwise. In one embodiment, the nanodiamond aerogel includes a polycondensation polymer aerogel having oxidized DND nanocrystals comprise twinning planes.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1D. FIG. 1A: BF-TEM of OxDND clusters. FIG. 1B: BF-TEM images of OxDND from FIG. 1A at a higher magnification, showing that clusters are formed from the aggregation of smaller nanodiamond crystals. FIG. 1C: Nitrogen adsorption isotherm. FIG. 1D: Pore size distribution of OxDND.

FIGS. 2A and 2B. FIG. 2A: NAA of ND90 and OxDND precursor. FIG. 2B: FTIR of ND90 and OxDND precursor.

FIGS. 3A and 3B. FIG. 3A: Digital photograph showing side-by-side color comparison of RF and nanodiamond aerogels following supercritical drying. Corresponding dark field optical microscopy images are shown below for each material at 100× magnification. FIG. 3B: HAADF TEM of the nanodiamond aerogel. Insets: HR-TEM showing lattice of a nanodiamond embedded within the aerogel (top-right), and a comparison of the SAED of the nanodiamonds in the aerogel compared to the nanodiamond precursor (bottom-right).

FIGS. 4A and 4B. FIG. 4A: FTIR spectra of OxDND, pure RF aerogel, and NDAG. FIG. 4B: XRD spectra of OxDND, RF aerogel, and NDAG.

FIGS. 5A-5D. FIG. 5A: SEM image of unpyrolyzed NDAG. FIG. 5B: High-magnification SEM image of NDAG. FIG. 5C: Nitrogen adsorption/desorption isotherm. FIG. 5C: BJH pore size distribution for NDAG.

### DETAILED DESCRIPTION

Disclosed herein are nanodiamond composites and methods for their synthesis. In particular, the nanodiamond composites include large-surface-area polymer composites that include a polymer and nanodiamond dispersed and bound therein. The resulting composites have certain properties of diamond (e.g., drug-loading sites with low toxicity) yet are inexpensive and relatively easy to fabricate. Aerogels formed using a polycondensation polymer are particularly described herein, although many polymer systems are compatible. Synthesis of the nanodiamond composites is achieved by polymerizing a mixture of nanodiamond and a polymer precursor.

In one aspect, a method of producing a nanodiamond composite is provided. In one embodiment, the method includes:

forming a gel by mixing oxidized diamond nanocrystals, a solvent capable of dispersing the oxidized diamond nanocrystals, and a polymer precursor system configured to form a polymer when reacted, wherein the gel comprises the solvent and the polymer having the oxidized diamond nanocrystals dispersed and bound therein.

According to this aspect, a composite is formed that includes oxidized nanodiamond crystals. The oxidized nature of the nanodiamond crystals allows that nanodiamond crystals to disperse in a solvent (e.g., a polar solvent like water or acetonitrile) for further processing. Oxidized nanodiamond crystals typically include hydroxyl and carboxylic acid moieties at least partially covering exterior surfaces of the nanodiamond crystals. These “dispersing” groups contrast with non-oxidized nanodiamond crystals, which have surfaces terminated primarily with —H moieties.

Dispersal of the nanodiamond crystals is essential for the method to produce the nanodiamond composite; otherwise, the nanodiamond crystals will aggregate in the solvent and will not be evenly distributed throughout the nanodiamond composite formed. Uneven distribution would negatively impact the available surface area of nanodiamond within the nanodiamond composite and, therefore, the properties upon which the nanodiamond is desired to provide (e.g., drug delivery, imaging, or capacitance). Accordingly, in one embodiment, the nanodiamond crystals are evenly distributed throughout the nanodiamond composite. As used herein, “evenly distributed” defines a state where the number density of nanodiamond crystals varies by 10% or less between two separate volumes of equal size (and not less than 1 μm²) within a contiguous nanodiamond composite.

Returning to the method, the diamond nanocrystals are dispersed in the solvent and the polymer precursor system. Accordingly, the polymer precursor system must be soluble in the solvent, just as the diamond nanocrystals must be dispersible in the solvent. Therefore, the mixture contains at least the solvent containing dispersed diamond and at least partially solvated polymer precursor. In the event that a catalyst is used as part of the polymer precursor system, both homogeneous and heterogeneous catalysts are compatible with the method, as long as the final product is the desired nanodiamond composite.

In one embodiment, the solvent is a polar solvent selected from the group consisting of acetonitrile and water. Acetonitrile provides several desirable properties, in that it is relatively volatile, having a lower evaporation temperature, compared to water and does not physisorb irreversibly to the polymer. While acetonitrile and water are exemplary solvents, any polar solvent capable of producing the desired nanodiamond composite is compatible with the disclosed methods.

In one embodiment, mixing comprises sonication. Sonication is useful for both dispersing the diamond nanocrystals and to provide energetic mixing.

In one embodiment, the mixing occurs at a temperature that does not exceed about 55° C. The disclosed method is conceived as a relatively low-temperature method that can be performed at room temperature (e.g., about 25° C.) or slightly elevated temperatures (which may result from the use of sonication). Certain known methods rely on much higher temperatures (e.g., 500° C. or greater using laser heating) in order to form high-surface-area composites. Such high temperatures are rendered inefficient compared to the disclosed method.

After mixing for a period sufficient to allow the polymer precursor system to form a polymer, a gel is formed that includes the polymer and the solvent contained within a network of the formed polymer. Sol-gel methods are well known and the produced gel is consistent with such methods. However, the composition of the gel is unique in that the polymer includes the nanodiamond crystals bound to the polymer and dispersed evenly throughout. As used herein, in one embodiment, the term “bound” indicates that the nanodiamond crystals are covalently bound to the polymer. Such binding is illustrated in the Example presented below related to resorcinol-formaldehyde polycondensation gels. In another embodiment, other binding mechanisms are also compatible with the method, including ionic binding, hydrogen binding, and physical capture of the nanodiamond crystals without chemical binding.

For certain applications, the gel produced by the method is useful without drying. For example, biocompatible water-based gels loaded with nanodiamonds can be used as delivery vehicles for bioactive materials, owing to the non-toxicity of nanodiamonds across a variety of cell types and the porosity of the polymer matrix allowing for gradual release kinetics. In particular, nanodiamond gels have been shown to carry and release the chemotherapeutic drugs doxorubicin and daunorubicin, as well as propolis, a dental restorative material. Accordingly, in certain embodiments, the method ends with production of a gel nanodiamond composite.

In other embodiments, however, the method proceeds with drying step to produce a solid nanodiamond composite. In one embodiment, the nanodiamond composite is a nanodiamond solid formed by the additional step of drying the gel to remove the solvent.

In one embodiment, the method further includes a step of washing the gel prior to drying the gel. A washing step can be applied to either the end-gel or end-solid embodiments discussed herein. In particular, a wash is used to remove impurities or components within the gel. An exemplary wash uses ethanol to wash acetonitrile from the gel. Removal of acetonitrile for ethanol is desirable because ethanol has a higher flash point, lower toxicity, and is miscible with liquid carbon dioxide (if an aerogel is to be formed). Acetone is another wash solvent useful for removing acetonitrile.

Aerogels

Aerogels are formed in certain embodiments of the method by removing the solvent from the gel using supercritical drying techniques (e.g., supercritical carbon dioxide). Accordingly, in one embodiment, the step of drying the gel comprises supercritically drying the gel to provide a nanodiamond aerogel that is a high-surface-area nanodiamond composite. In one embodiment, supercritically drying the gel comprises supercritical point drying. These aerogel-forming techniques are described in the Example below.

The aerogels produced are relatively high surface area, which provides an ideal structure for desirable nanodiamond applications as described herein.

Templated Structures

Another type of high-surface-area composite can be formed using templating. Accordingly, in one embodiment, the method further includes the steps of:

providing a template onto which the step of forming the gel is performed, to provide a templated gel; and

drying the templated gel to remove the solvent and provide a templated nanodiamond composite.

Similar techniques have been used in other polymer systems and are equally applicable to the nanodiamond composite systems disclosed herein. See, e.g., S J Bryant, J L Cuy, K D Hauch, B D Ratner, “Photo-Patterning of Porous Hydrogels for Tissue Engineering”, Biomaterials 2007, 28, 2978-2986; and T F Baumann and J H Satcher Jr., “Template-Directed Synthesis of Periodic Macroporous Organic and Carbon Aerogels,” Journal of Non-Crystalline Solids 2004, 350, 120-125.

In one embodiment, the template comprises a plurality of nanospheres. Exemplary nanospheres include polystyrene nanospheres, which are commercially available and readily dissolved in various solvents (e.g., organic aromatic solvents).

Solubility in solvents is important for the templating material if the templating material is to be dissolved. In one embodiment, the method further includes a step of removing the template from the templated nanodiamond composite to provide a high-surface-area nanodiamond composite. By dissolving the templating material, vacancies are left in the nanodiamond composite that yield high surface area structures with controlled porosity, as desired for various applications disclosed herein. Compared to aerogel nanodiamond composites, template composites can be formed with a regular packing of template materials (e.g., spheres), which will yield a template composite having a regular, repeating, and interconnected pore structure. This periodicity and interconnectedness, as opposed to random vacancies in conventional aerogels, provide enhanced mass transport properties that improve the performance of such materials for catalysis or separation applications. In addition, if the templated pores are similar in size to optical wavelengths, such materials can be used as photonic crystals that allow for simple manipulation of light.

Detonation Nanodiamond

In one embodiment, the oxidized diamond nanocrystals are oxidized detonation nanodiamond (DND) nanocrystals. DND nanocrystals are formed by detonating explosives containing carbon, followed by purification of the produced soot, which produces nanocrystals of diamond. DND nanocrystals are commercially available and well-studied for both therapeutic and diagnostic applications. Due to their commercial availability and physical qualities, DND nanocrystals are exemplary diamond nanocrystal materials for use in the disclosed method.

While DND nanocrystals are commercially available, the as-purchased DND nanocrystals are not compatible with the disclosed method. Instead, the DND nanocrystals must be processed in order to make them compatible. In one embodiment, the oxidized DND nanocrystals are formed by thermally oxidizing DND in an oxygen-containing atmosphere. In one embodiment, the thermal oxidation is for a temperature and time sufficient to remove amorphous carbon soot and generate chemically reactive surface-oxygen functional groups on the DND, thus producing oxidized DND. Oxidizing the DND nanocrystals forms oxygen-containing moieties on the surface of the DND nanocrystals (e.g., hydroxyl and carboxylic acid moieties). These moieties allow the DND nanocrystals to disperse in the solvent. Thermal oxidation is a simple, cost-effective method of oxidizing the DND nanocrystals. Other oxidation methods are also compatible.

In one embodiment, the oxygen-containing atmosphere is air. Oxidation of the DND nanocrystals can be performed in air or other oxygen containing atmosphere. Oxidation in air is another efficient and cost-effective production step compatible with the disclosed method.

In one embodiment, the DND nanocrystals have a smallest dimension of about 1 nm to about 10 nm. This is the size range typically produced by the DND process. As used herein, the “smallest dimension” refers to the shortest distance between opposing sides of the nanocrystal. For example, the diameter of a sphere, shortest leg of a pyramid, or edge of a cube.

Plasma Nanodiamond

In one embodiment, the oxidized diamond nanocrystals are oxidized plasma-generated diamond nanocrystals. Generation of diamond nanocrystals via plasma is an emerging area of study. Such plasma-generated diamond nanocrystals can be incorporated into the methods disclosed herein. Oxidization (e.g., by thermal oxidation) of plasma-generated diamond nanocrystals provides oxidized plasma-generated diamond nanocrystals for incorporation into the nanodiamond composite. Diamond nanocrystals 2 to 5 nm in diameter have been shown to nucleate at room temperature and atmospheric pressure by continuously dissociating a mixture of ethanol vapor, argon, and hydrogen gas in a microplasma. The atomic hydrogen selectively etches non-diamond carbon and thermodynamically stabilizes the nanodiamond surfaces; furthermore, the as-synthesized particles contain oxygenated surface groups, obviating the need for thermal air-oxidation. Reference: A Kumar, P A Lin, A Xue, B Hao, Y K Yap, R M Sankaran, “Formation of Nanodiamonds at Near-Ambient Conditions Via Microplasma Dissociation of Ethanol Vapour,”. Nature Communications 2013, 4:2618.

Polycondensation Precursors

An exemplary polymer useful in the method is a polycondensation polymer. Accordingly, in one embodiment, the polymer precursor system is a polycondensation precursor system comprising a first polycondensation precursor and a second polycondensation precursor configured to form a polycondensation polymer when reacted with the first polycondensation precursor. Polycondensation polymer systems are well known and any can be used with the disclosed methods as long as the desired nanodiamond composite is produced.

In one embodiment, the first polycondensation precursor is a diol and the second polycondensation precursor comprises an aldehyde. Such as system is a well-known polycondensation system that is described in the Example below. In one embodiment, the diol is resorcinol and the aldehyde is formaldehyde. Other representative formaldehyde-based systems include the combination with melamine, urea, or phenol.

Certain polycondensation polymer systems are known to be enhanced by the presence of a catalyst. Accordingly, in one embodiment, the step of forming the gel comprises mixing a catalyst configured to facilitate formation of the polycondensation polymer with the polycondensation precursor system. In one embodiment, the catalyst is hydrochloric acid. In one embodiment, the catalyst is a photoacid. Essentially any acid can be used to catalyze the polycondensation reaction in these embodiments, as long as the desired nanodiamond composite is formed. In one embodiment, if the solvent is water, the catalyst is a salt that forms a basic solution when dissolved, such as sodium carbonate or potassium carbonate.

Radical Polymer

Another type of polymer precursor system is one configured to form a polymer through radical polymerization. Accordingly, in one embodiment, the polymer precursor system is a radical polymerization precursor system comprising a radical polymer precursor and an initiator configured to polymerize the radical polymer precursor. Radical polymerization systems are well known and any can be compatible with the disclosed method, as long as the desired nanodiamond composite is formed. Representative radical polymerization systems include polyethylene glycol (PEG) functionalized moieties subject to radical polymerization (e.g., diacrylic functionalization). Representative initiators include the UV-activated initiators based on phenyl ketone moieties. Compared to polycondensation, radical polymerization offers the advantages of rapid reaction kinetics (on the order of seconds to minutes) as well as superior temporal and spatial control of the polymerization, by adjusting the exposure time and projection area of the light source (for light-activated systems), respectively. On the other hand, photopolymerization is inhibited by the presence of oxygen, requiring an inert atmosphere for optimal results, which may be difficult to achieve on a large scale. Furthermore, photopolymerization systems are more prone than polycondensation systems to volume shrinkage over the course of the reaction, which is undesirable if a high surface area material is to be obtained.

Nanodiamond Composite Compositions

In addition to the methods described herein, nanodiamond compositions formed using the disclose methods are also provided. Accordingly, in another aspect, a nanodiamond composite is provided that is formed by the methods described herein.

In certain embodiments the nanodiamond composites have a relatively large surface area. This large surface area is formed in representative methods by the disclosed aerogel or templating processes. In one embodiment, the surface area of the nanodiamond composite is about 350 m²/g to about 1000 m²/g. In another embodiment, the surface area of the nanodiamond composite is about 450 m²/g to about 600 m²/g. When forming the nanodiamond composite, the surface area can be partially controlled by the amount of solvent used. Particularly, a higher amount of solvent compared to the polymer precursor system and the diamond nanocrystals will produce a higher surface area. This is particularly true when forming an aerogel nanodiamond composite.

Bulk density (i.e., per unit area, including vacancies) is another way in which the nanodiamond composites are characterized. In one embodiment, the bulk density of the nanodiamond composite is about 150 mg/cm³ to about 500 mg/cm³. When forming the nanodiamond composite from polycondensation precursors, the bulk density can be partially controlled by adjusting the proportions of the first and second precursors (e.g., resorcinol and formaldehyde). This is particularly true when forming an aerogel nanodiamond composite. For example, if the solvent is acetonitrile, the resorcinol-to-solvent ratio is typically 1:94 (molar); a smaller amount of resorcinol for a given volume of solvent yields a less dense polymer network.

Any amount of diamond nanocrystal can be incorporated into the diamond composite, as long as the diamond composite maintains structural integrity. Too high of a diamond nanocrystal loading weight percentage will prevent the high surface area structure from being formed. This upper limit is dependent on the size of the diamond nanocrystals and the polymer used to form the nanodiamond composite. In one embodiment, the diamond nanocrystals are about 1% to about 25%, by weight, of the nanodiamond aerogel. In the exemplary system using resorcinol (R), formaldehyde (F), acetonitrile, and oxidized DND (oxND), the following has been found. The maximum oxND loading with which an aerogel has successfully been made is R:oxND=2:1 (by weight), which corresponds to 25 wt % oxND in the final aerogel assuming R:F=1:2 (molar) and that neither the catalyst nor the solvent contribute to the aerogel mass. The RF will polymerize with the catalyst on their own so the lower end of the range is bounded by any presence of oxND (e.g., 1%).

In certain embodiments, the diamond nanocrystal is detonation nanodiamond (DND). As noted above, DND is particularly compatible with the disclosed methods because it is inexpensive and can be readily oxidized for compatibility with solvent processing. DND has certain physical characteristics that distinguish it from nanodiamond crystals formed from other methods (e.g., laser-heated diamond anvil methods). In particular, the DND includes certain heavy metals and the DND nanocrystals include twinning planes (Turner et al., Adv. Funct. Mat. 19, 2116-2124, (2009)), which are not present in other nanodiamond crystals. Accordingly, in one embodiment, the nanodiamond crystals further includes one or more heavy metals. In one embodiment, the one or more heavy metals includes 100 ppm or greater of iron. Iron is typically in the form of an iron oxide.

In one embodiment, the nanodiamond crystals include twinning planes. Twin planes in particular are significant because nitrogen-vacancy centers, which are point defects in diamond where a nitrogen atom substituting for a carbon atom with a corresponding lattice vacancy, are known to occur preferentially at twin boundaries. Nitrogen-vacancy centers are magnetic and exhibit photoluminescence that is coupled to their spin state, making them potentially useful for applications in quantum computing and magnetic field sensing.

DND Aerogels

In yet another aspect, a nanodiamond aerogel is provided, whether made from the disclosed methods or otherwise. In one embodiment, the nanodiamond aerogel includes a polycondensation polymer aerogel having oxidized DND nanocrystals comprise twinning planes.

In certain embodiments the nanodiamond aerogel have a relatively large surface area. This large surface area is formed in representative methods by the disclosed aerogel process, as described in the Example below. In one embodiment, the surface area of the nanodiamond aerogel is about 350 m²/g to about 1000 m²/g. In another embodiment, the surface area of the nanodiamond aerogel is about 450 m²/g to about 600 m²/g. When forming the nanodiamond aerogel, the surface area can be partially controlled by the amount of solvent used. Particularly, a higher amount of solvent compared to the polymer precursor system and the diamond nanocrystals will produce a higher surface area. This is particularly true when forming an aerogel nanodiamond composite.

Bulk density (i.e., per unit area, including vacancies) is another way in which the nanodiamond aerogels are characterized. In one embodiment, the bulk density of the nanodiamond aerogel is about 150 mg/cm³ to about 500 mg/cm³. When forming the nanodiamond aerogels from polycondensation precursors, the bulk density can be partially controlled by adjusting the proportions of the first and second precursors (e.g., resorcinol and formaldehyde). This is particularly true when forming a nanodiamond aerogel. For example, if the solvent is acetonitrile, the resorcinol-to-solvent ratio is typically 1:94 (molar); a smaller amount of resorcinol for a given volume of solvent yields a less dense polymer network.

Any amount of diamond nanocrystal can be incorporated into the nanodiamond aerogel, as long as the nanodiamond aerogel maintains structural integrity. Too high of a diamond nanocrystal loading weight percentage will prevent the high surface area structure from being formed. This upper limit is dependent on the size of the diamond nanocrystals and the polymer used to form the nanodiamond aerogel. In one embodiment, the diamond nanocrystals are about 1% to about 25%, by weight, of the nanodiamond aerogel. In the exemplary system using resorcinol (R), formaldehyde (F), acetonitrile, and oxidized DND (oxND), the following has been found. The maximum oxND loading with which an aerogel has successfully been made is R:oxND=2:1 (by weight), which corresponds to 25 wt % oxND in the final aerogel assuming R:F=1:2 (molar), and that neither the catalyst nor the solvent contribute to the aerogel mass. The RF will polymerize with the catalyst on their own so the lower end of the range is bounded by any presence of oxND (e.g., 1%).

As noted above, DND is particularly beneficial in general, and particularly in nanodiamond aerogels, because it is inexpensive and can be readily oxidized for compatibility with solvent processing. In one embodiment, the DND crystals further include one or more heavy metals. In one embodiment, the one or more heavy metals includes 100 ppm or greater of iron. In one embodiment, the DND crystals include twinning planes.

The following examples are included for the purpose of illustrating, not limiting, the disclosed embodiments.

### EXAMPLES

The rapid sol-gel synthesis of macroscopic quantities of nanodiamond aerogel is reported at standard temperature and pressure using acid-catalyzed covalent crosslinking of air-oxidized detonation-nanodiamond (DND) nanocrystals. Acetonitrile acts as a polar, aprotic solvent both to form colloidal dispersions of DND particles as well as to conduct acid-catalyzed polycondensation reactions between resorcinol and formaldehyde (RF) small molecule precursors. Several characterization techniques show that nanodiamond grains are connected via covalent bonding with RF molecules to form a porous, three-dimensional network. Solvent exchange into liquid carbon dioxide and subsequent supercritical drying of nanodiamond aerogels are used to recover low-density (151 mg/cm³), three-dimensional monolithic aerogels that exhibit surface areas in excess of 589 m²/g. The large accessible pore-volume from the rapidly synthesized, macroscopic nanodiamond aerogel materials suggests a range of potential applications in catalysis, sensing, energy storage, as well as inert excipients for small-molecule pharmaceuticals.

### I. Introduction

High-pressure, high-temperature (HPHT) synthetic approaches have been reported recently to produce high surface-area diamond aerogel materials in a laser-heated diamond anvil cell as well as mesoporous diamond using a multi-anvil press. These materials are of interest, since aerogels are lightweight, have high surface areas, and contain abundant open pores which can be readily loaded with drugs or other compounds to be used as an effective payload delivery vessel. However, HPHT processing is costly in terms of both capital equipment as well as processing time. Developing chemical approaches to high surface area diamond synthesis would greatly increase availability and reduce cost for a range of applied and fundamental scientific applications. Here we report a rapid, low-cost alternative to making diamond aerogels by forming covalent bonds between individual nanocrystalline grains using a sol-gel reaction between resorcinol and formaldehyde (RF) molecular precursors.

### II. Experimental

A. Oxidization

DND materials (ND90, Dynalene) were oxidized in ambient air within a tube furnace (Lindberg Blue) at 450° C. for 8 hours to remove amorphous carbon soot as well as to generate chemically reactive surface-oxygen functional groups (carboxylic acids, anhydrides, etc.). It has been experimentally shown that the oxidation process serves to reduce the size of the nanodiamonds, removes graphitic material, and increases the intensity of the nitrogen vacancy centers within the nanodiamonds. The final oxidized nanodiamond (OxDND) was used during synthesis and subsequent characterization of the nanodiamond aerogels.

B. Neutron Activation Analysis (NAA)

Neutron activation analysis was used to quantify the trace impurity content in the precursor and oxidized nanodiamonds. NAA technique is preferred for trace element quantification due to its high sensitivity and accurate, consistent, fast results with minimal sample preparation. The samples are bombarded with neutrons to form radioactive nuclides. These radioactive nuclides decay, emitting gamma-ray radiation that can be quantitatively monitored. Decay schemes can be single events or sequential multi-step progressions, as is the case for Ce-133. The NAA data presented in this study was obtained using a TRIGA Mark II nuclear reactor. The samples (10 mg each) were enclosed in polyethylene capsules and were irradiated for 30 minutes. The study was performed at a thermal operating power of 100 kW, 4×10¹² neutrons/cm²sec thermal flux, and 4.8×10¹² neutrons/cm²sec fast and epithermal flux. Each sample was counted while positioned near the surface of a 25 cm², trapezohedral, germanium, lithium-drifted semiconductor detector (Nuclear Diodes), which is constantly cooled by liquid nitrogen (77 K). The dead time between the end of irradiation and the start of collection was 5 minutes. Ratiometric analyses were performed comparing experimental activities (μCi/unit) to calculated activities per given element and reactor efficiency to determine the concentrations of metallic impurities.

C. Synthesis

Nanodiamond aerogels (NDAG) were prepared using OxDND materials based on a modified time-efficient, acid-catalyzed method for preparing resorcinol-formaldehyde aerogels. Briefly, 1.67 mL of high purity acetonitrile (AN) (OmniSolv) was sonicated with 17.5 mg of detonation nanodiamonds for 15 minutes in polypropylene tubes. Following dispersion of OxDND within the AN solvent, 37.6 mg of resorcinol (R, Sigma-Aldrich) and 49.4 μL of formaldehyde (F, Sigma-Aldrich, 37% w/w aqueous solution with methanol as a stabilizer) was added to the mixture and sonicated for 20 minutes until all the resorcinol was dissolved (1:2 molar ratio of R:F). Lastly, 4 μL of HCl (C, Sigma-Aldrich, 37% ACS reagent) was added as a catalyst and the mixture was further sonicated for 30 minutes (8:1 molar ratio R:C). The R:OxDND mass ratio used for the sol-gel reaction was 2:1. The mixture (sol) gelled within 30 minutes at room temperature during sonication. The resulting NDAG molar ratio of R:AN was 1:94. The gels were then washed with anhydrous ethanol (4× over 48 hrs) and supercritically dried in CO₂ (E3100 critical point dryer, Quorum Technologies). Supercritical point drying (SCPD) was used to dry the wet gel in order to preserve the porosity of the solid matrix.

D. Surface Area and Pore Volume

Surface area and pore volume measurements were performed by the Brunauer-Emmett-Teller (BET) and Barrett-Joyner-Halenda (BJH) methods, respectively, using a Nova 2200e analyzer (Quantachrome) with nitrogen gas as the adsorbate. The OxDND were degassed for 17 hours at 125° C. prior to performing the BET measurement while the NDAG was loaded in the analyzer immediately following supercritical point drying. High temperature degassing was avoided given discoloration of the aerogel that was observed at 200° C.

E. Electron Microscopy

The NDAG material was analyzed by using a FEI Sirion scanning electron microscope (SEM). Samples were prepared for SEM characterization by coating the material with a 10 nm layer of sputtered gold. The samples were also analyzed using transmission electron microscopy (TEM, FEI Tecnai G2 F20, 200 kV accelerating voltage) to verify the presence of nanodiamonds within the RF matrix. High-resolution bright field (HR-BF) imaging, select area electron diffraction (SAED), and high angle annular darkfield (HAADF) scanning transmission imaging were performed to characterize the NDAG microstructure.

F. Fourier Transform Infrared Spectroscopy (FTIR)

Attenuated Total Reflectance FTIR (ATR-FTIR) spectroscopy was performed using a Bruker VERTEX 70 Fourier Transform Infrared Spectrometer with an integrated Platinum-ATR-accessory (Unit A225/Q1). The resulting data was used to identify the functional groups, impurities, and adsorbed molecules on the surface of the precursor materials and synthesized aerogels.

G. X-Ray Diffraction (XRD)

XRD was performed using a Bruker D8 Discover X-ray diffractometer equipped with a General Area Detector Diffraction Systems (GADDS) XRD system using a Cu K-alpha source. Powder samples were aligned in the system using the laser guidance system provided in the instrument.

### III. Results and Discussion

A. Precursor Characterization

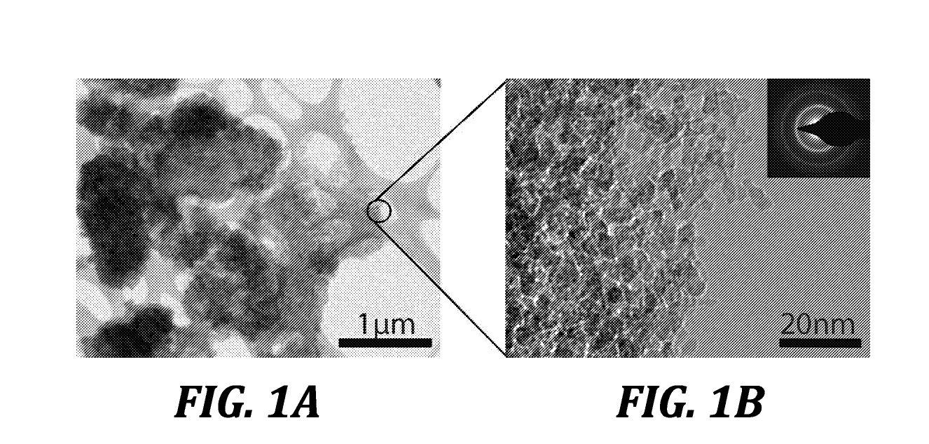

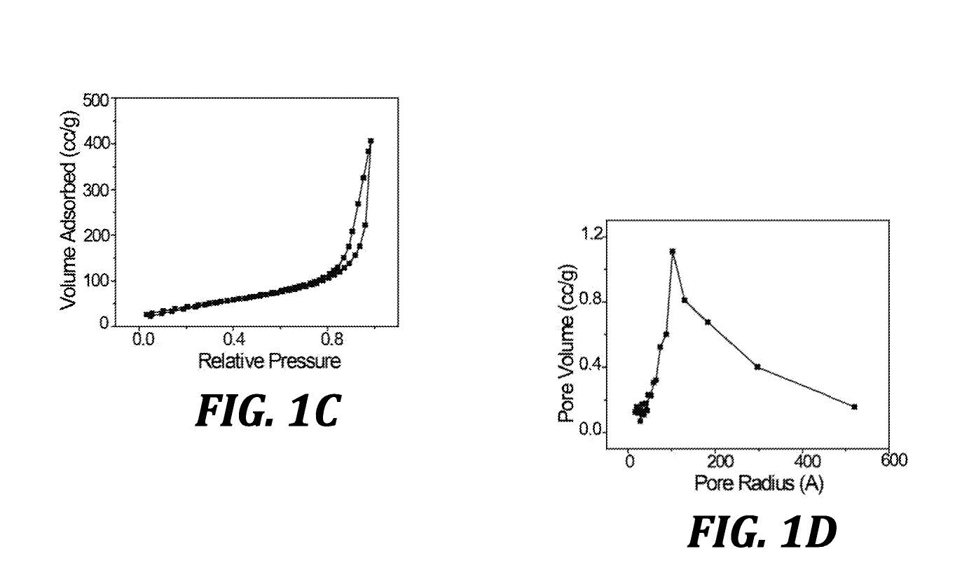

TEM images of the precursor OxDND (FIGS. 1A and 1B) show that the nanodiamonds are aggregated into clusters of roughly 1 μm diameter, being made up of smaller crystalline grains of approximately 5 nm in diameter. The OxDND are polycrystalline, as verified by the SAED pattern shown in the inset in FIG. 1B. In addition, the BET surface area of the OxDND, as calculated from the nitrogen adsorption/desorption isotherm in FIG. 1C, is 161 m²/g, which supports the fact that the nanodiamond clusters have a high surface area. The pore volume distribution shown in FIG. 1D shows that the OxDND has an average pore volume of 0.613 cm³/g.

The quality, physical/chemical properties, and potential use in specific applications of nanodiamonds depend critically on the purity of the material. The purity of the nanodiamond is determined by oxidative isolation of the diamond fraction from the synthetic detonation soot (predominately graphitic carbon) as well as by the remaining non-carbon impurities originating from the source explosive materials, walls of the detonation chamber, and detonator. The variation of these non-carbon impurities is extensive and includes both metal (Fe, Ti, Al, Cr, Si, etc.) and non-metal (S, P, B, etc.) elements by up to 8 wt. %.

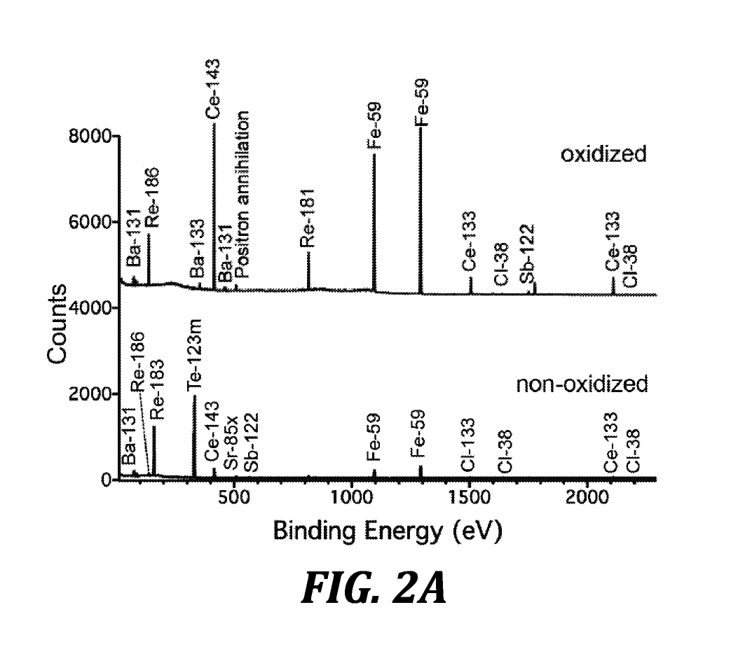

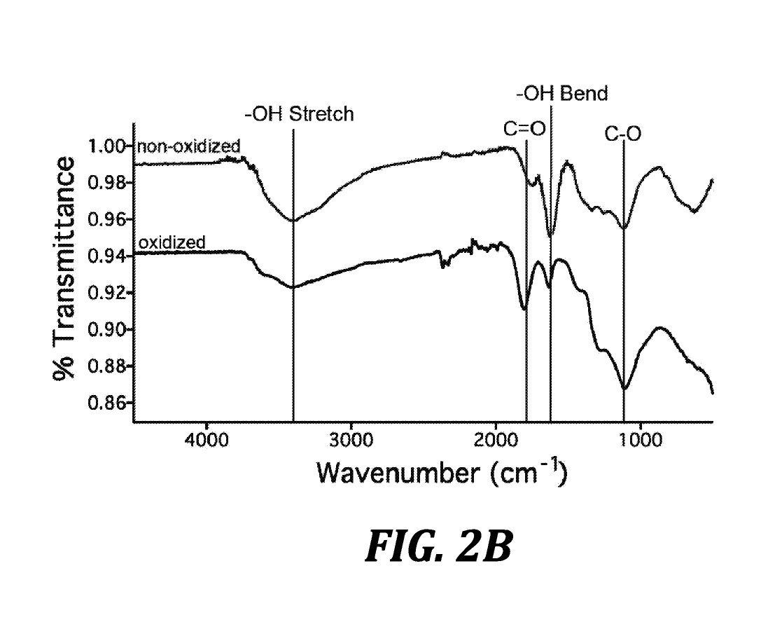

NAA was used to characterize these impurities for powder precursors used in this experiment. The NAA data shown in FIG. 2A shows that several metallic impurities (rhenium, ruthenium, cerium, and iron) are present in the analyzed samples. The elements chlorine, barium, tellurium, strontium, and antimony comprise the nonmetallic impurities. In general, there is significant variation in impurities of the precursor nanodiamonds. Iron and cerium were present in all samples and generally increase in concentration during the oxidation process of nanodiamonds. The concentration of iron is observed to increase from 29 ppm in as-received DND material to nearly 500 ppm following air oxidation. The mass of carbon in a given sample is reduced during the oxidation process following the formation of gas-phase CO₂ and CO molecules. In contrast to carbon, iron does not form volatile oxidation byproducts at these oxidation temperatures (450° C.), resulting in an increase in the residual concentration of iron. Furthermore, results indicate that the oxidation process tends to remove the trace elements ruthenium and tellurium. The list of elements identified by NAA in precursor nanodiamond (ND90) and OxDND is given in Table 1.

TABLE 1
List of elements identified by NAA.

| | | |
|---|---|---|
| | Precursor Concentration | Oxidized Concentration |
| Nuclide | (ND90) | (OxDND) |

| Cl-38 | 151 | ppt | 163 | ppt |
|---|---|---|---|---|
| Fe-59 | 29 | ppm | 494 | ppm |
| Sr-85x | 655 | ppb | 6 | ppt |
| Ru-103 | 197 | ppt | no trace | |
| Te-123m | 443 | ppb | no trace | |
| Re-186 | 37 | ppt | 492 | ppt |
| Ba-133 | 5 | ppb | 95 | ppb |
| Ba-131 | 4 | ppm | 6 | ppm |

FTIR spectra shown in FIG. 2B indicates that all of the spectra show the surface hydroxyl (O—H) vibrations bands (stretch regions from 3650-2920 cm⁻¹ and bend regions from 1510-1700 cm⁻¹) and C═O bonds of carboxylic acid (region from 1700-1880 cm⁻¹). Also, the peak near 1100 cm⁻¹ is related to C—O stretching vibration present in the DND and OxDND. The small peak on the OxDND spectrum near 2324-2360 cm⁻¹ is due to adsorbed molecules of CO₂.

B. Diamond Aerogel Characterization

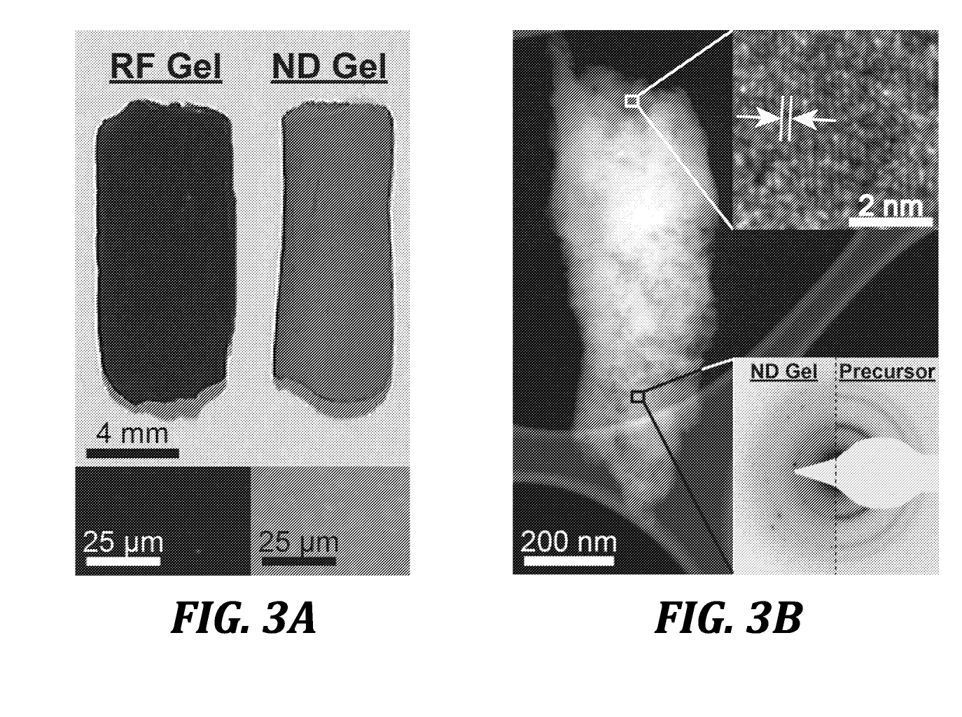

There is a dramatic lightening in color of the recovered NDAG material in comparison with pure RF aerogel, as shown in FIG. 3A. The final color of the NDAG is pinkish-white in contrast to the deep-red color of the RF aerogel at an identical R:AN ratio. Despite the contrast in color, both RF and NDAG were similar in shape and mechanical stability and easily held under standard handling and analytic procedures. TEM SAED (FIG. 3B, inset) confirms the presence of OxDND in the aerogel matrix, showing a polycrystalline ring pattern. HAADF TEM (FIG. 3B) shows that the NDAG samples exhibit a highly porous microstructure that is maintained following SCPD.

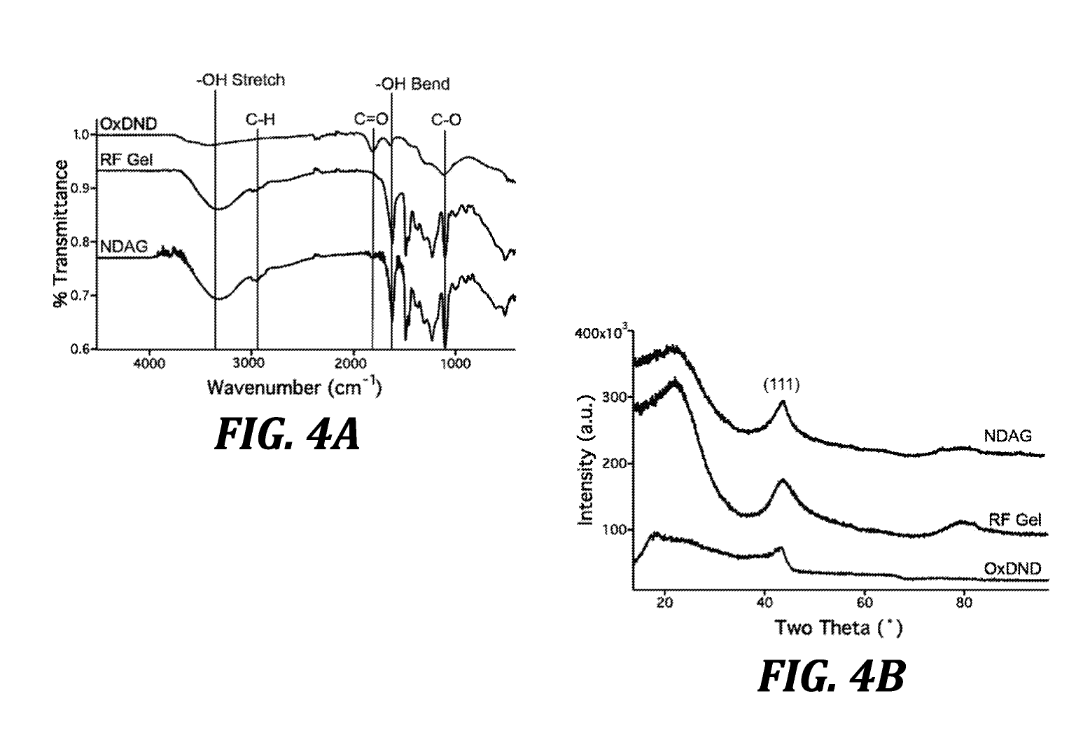

FIG. 2B and FIG. 4A show FTIR spectra taken in air of the ND90 precursor, OxDND, the RF aerogel control, and NDAG samples. Due to the oxidative nature of the detonation, as well as the air oxidation of the precursor nanodiamonds, the surface of the OxDND contains various oxygen-containing groups. All samples show C—O—C stretching bands from ethers, acid anhydrides, lactones, and epoxy groups in the region 1100-1370 cm⁻¹. Adsorbed water gives strong absorption bands in the 3500-3300 and 1620-1630 cm⁻¹ (bending mode) regions. Carbonyl C═O peaks (1700-1865 cm⁻¹ for carbonyls in ketones, carboxylic acids, acid anhydrides, esters and lactones) are not observed in the pure RF gel but appear in the NDAG due to the addition of nanodiamonds. Also, neither of the precursor nanodiamonds shows the presence of C—H or CH₂ stretching, as opposed to the RF aerogel and NDAG, since they are not bonded with any resorcinol/formaldehyde condensation polymers. The wavenumbers of the absorption peaks corresponding to each vibrational mode identified by the FTIR are shown in Table 2.

TABLE 2
Wavenumbers of absorption peaks in FTIR spectra.

| | ND90 | OxDND | RF gel | NDAG |
|---|---|---|---|---|
| —OH stretch | 3400 | 3406 | 3321 | 3300, 3790 |
| —OH bend | 1630 | 1628 | 1610 | 1608 |
| C—H stretch | — | — | 2975 | 2930, 2970 |
| C═O | 1755 | 1800 | — | 1800 |
| C—O | 1115, 1250, | 1100, 1273 | 1093, 1217, | 1092, 1219, |
| | 1335 | | 1294, 1360 | 1294, 1367, |
| | | | | 1379 |
| —C═C—H | 627 | — | 987 | 987 |
| C—H out-of- | — | — | 879 | 839, 877 |
| plane (‘oop’) | | | | |
| —CH₂— | — | — | 1445, 1475 | 1444, 1475 |

Analysis of the XRD spectra indicates the presence of amorphous hydrocarbons within both RF and nanodiamond aerogel samples following sol-gel cross-linking reactions. The peak at around 2θ=43° is the characteristic (111) diffraction peak of diamond. Both aerogels exhibit an additional broader, weaker peak at 2θ=75°, indicating that they are partially graphitic.

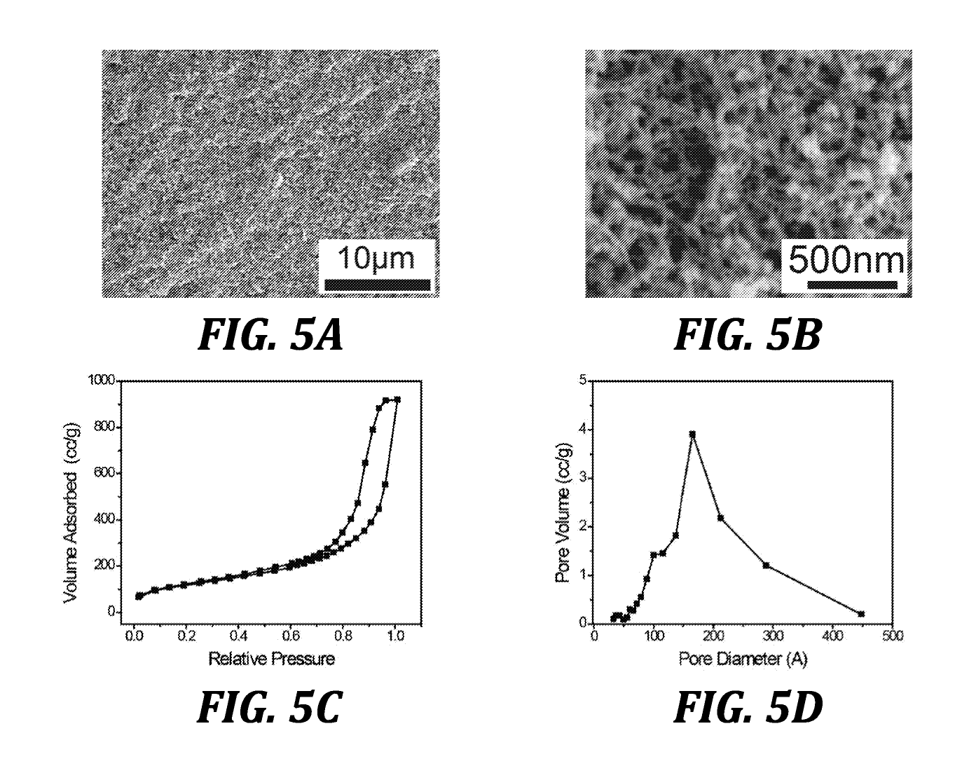

The microstructure of recovered NDAG materials were observed further using SEM. The surface of the NDAG appears to be highly porous as shown in FIGS. 5A and 5B. FIGS. 5C and 5D show the nitrogen adsorption/desorption isotherm and pore size distribution, respectively, of the NDAG with R:AN molar ratio of 1:94 and R:OxDND weight ratio of 2:1. The micropore surface area for this gel is 589 m²/g. Bulk density was approximated by dividing the measured mass of a typical sample over its macroscopic volume and was found to be ˜151 mg/cm³.

### IV. Conclusion

In conclusion, a fast sol-gel process is reported for preparing macroscopic quantities of nanodiamond aerogel (NDAG) materials with high surface areas based on an acid-catalyzed condensation reactions in a polar, aprotic solvent (acetonitrile). Metallic impurities within detonation-nanodiamond precursor materials were analyzed using neutron activation analysis and air oxidation was observed to increase the amount of iron by approximately one order of magnitude. Transmission electron microscopy was used to show that the NDAG material contains nanodiamonds dispersed throughout the resorcinol-formaldehyde matrix.

As used herein, the term “about” indicates that the subject number can be increased or decreased by 5% and still fall within the embodiment described or claimed.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method of producing a nanodiamond composite, comprising:
forming a gel by mixing oxidized diamond nanocrystals, a solvent capable of dispersing the oxidized diamond nanocrystals, and a polymer precursor system configured to form a polymer when polymerized, wherein the gel comprises the solvent and the polymer having the oxidized diamond nanocrystals dispersed and bound therein.

2. The method of claim 1, wherein the nanodiamond composite is a nanodiamond solid formed by the additional step of drying the gel to remove the solvent.

3. The method of claim 2, further comprising a step of washing the gel prior to drying the gel.

4. The method of claim 2, wherein the step of drying the gel comprises supercritically drying the gel to provide a nanodiamond aerogel that is a high-surface-area nanodiamond composite.

5. The method of claim 4, wherein supercritically drying the gel comprises supercritical point drying.

6. The method of claim 1, further comprising the steps of:
providing a template onto which the step of forming the gel is performed, to provide a templated gel; and
drying the templated gel to remove the solvent and provide a templated nanodiamond composite.

7. The method of claim 6, wherein the template comprises a plurality of nanospheres.

8. The method of claim 6, further comprising a step of removing the template from the templated nanodiamond composite to provide a high-surface-area nanodiamond composite.

9. The method of claim 1, wherein the oxidized diamond nanocrystals are oxidized detonation nanodiamond (DND) nanocrystals.

10. The method of claim 9, wherein the oxidized DND nanocrystals are formed by thermally oxidizing DND nanocrystals in an oxygen-containing atmosphere.

11. The method of claim 10, wherein the oxygen-containing atmosphere is air.

12. The method of claim 10, wherein the thermal oxidation is for a temperature and time sufficient to remove amorphous carbon soot and generate chemically reactive surface-oxygen functional groups on the DND nanocrystals, thus producing oxidized DND nanocrystals.

13. The method of claim 9, wherein the DND nanocrystals have a smallest dimension of about 1 nm to about 10 nm.

14. The method of claim 1, wherein the oxidized diamond nanocrystals are oxidized plasma-generated diamond nanocrystals.

15. The method of claim 1, wherein the solvent is a polar solvent selected from the group consisting of acetonitrile and water.

16. The method of claim 1, wherein the polymer precursor system is a polycondensation precursor system comprising a first polycondensation precursor and a second polycondensation precursor configured to form a polycondensation polymer when reacted with the first polycondensation precursor.

17. The method of claim 16, wherein the first polycondensation precursor is a diol and the second polycondensation precursor comprises an aldehyde.

18. The method of claim 17, wherein the diol resorcinol and the aldehyde is formaldehyde.

19. The method of claim 16, wherein the step of forming the gel comprises mixing a catalyst configured to facilitate formation of the polycondensation polymer with the polycondensation precursor system.

20. The method of claim 19, wherein the catalyst is hydrochloric acid.

21. The method of claim 1, wherein the polymer precursor system is a radical polymerization precursor system comprising a radical polymer precursor and an initiator configured to polymerize the radical polymer precursor.

22. The method of claim 1, wherein mixing comprises sonication.

23. The method of claim 1, wherein the mixing occurs at a temperature that does not exceed 55° C.

24. A nanodiamond composite formed by the method of claim 1.

25. A nanodiamond aerogel comprising a polycondensation polymer aerogel having oxidized DND nanocrystals comprise twinning planes.

26. The nanodiamond aerogel of claim 25, wherein the surface area is about 350 m²/g to about 1000 m²/g.

27. The nanodiamond aerogel of claim 25, wherein the bulk density is about 150 mg/cm³ to about 500 mg/cm³.

28. The nanodiamond aerogel of claim 25, further comprising one or more heavy metals.

29. The nanodiamond aerogel of claim 28, wherein the one or more heavy metals comprises 100 ppm or greater of iron.

30. The nanodiamond aerogel of claim 25, wherein the oxidized DND nanocrystals are 1% to 25%, by weight, of the nanodiamond aerogel.
